(19) United States
(12) Patent Application Publication
(10) Pub. No.: US 2007/0025273 A1
(43) Pub. Date: Feb. 1, 2007

(54) Methods and systems for detecting video signals and sources

(76) Inventor: Yau Wing Chung, Fremont, CA (US)

Correspondence Address: Min, Hsieh & Hack, LLP, Suite 630, 8270 Greensboro Drive, McLean, VA, 22102, US

(21) Appl. No.: 11/249,313

(22) Filed: Oct. 14, 2005

Related U.S. Application Data
(60) Provisional application No. 60/703,433, filed on Jul. 29, 2005.

(51) Int. Cl. H04L 12/28

(52) U.S. Cl. 370/254

(57) ABSTRACT

A list of most recently utilized ports is maintained in memory. The video display system checks each port in the recently utilized ports list to determine if any video sources are connected to the recently utilized ports. If no sources are connected to the recently utilized ports, the video display system sequentially checks the remaining ports not stored in the list.

### CROSS-REFERENCE TO RELATED APPLICATIONS

This application claims priority to U.S. Provisional Patent Application Ser. No. 60/703,433 filed on Jul. 29, 2005, the disclosure of which is incorporated in its entirety by reference herein.

### FIELD

Aspects of the present invention generally relate to video display methods and systems.

### BACKGROUND

Conventional video devices have multiple inputs and outputs for receiving input signals and outputting signals, respectively. Normally to detect if a device is connected to one of the multiple inputs, the video device will sequentially check every input port. If the display device has a large number of ports, the display device may be delayed while trying to determine which input port is being utilized.

### SUMMARY

Aspects of the present invention concern a method for detecting a video signal, comprising: maintaining a list of recently utilized ports, wherein the recently utilized ports are arranged sequentially in the list based on a most recently utilized port; evaluating each of the recently utilized ports to determine if a source is coupled to one of the recently utilized ports; evaluating other ports not contained in the list if none of the recently utilized ports is coupled to the source; and updating the list if the recently utilized ports or the other ports is determined to be coupled to the source.

Further, aspects of the present invention concern a video device, comprising: a video display device display video; ports coupled to the video display device for receiving signals including video signals; memory for maintaining a list of recently utilized ports, wherein the recently utilized ports are arranged sequentially in the list based on a most recently utilized; and logic for evaluating each of the recently utilized ports to determine if a source is coupled to one of the recently utilized ports, evaluating other ports not in the list if none of the recently utilized ports is coupled to the source, and updating the list if the recently utilized ports or the other ports is determined to be coupled to the source.

Further, aspects of the present invention concern a video device, comprising: means for displaying video; means for receiving signals including video signals; means for maintaining a list of recently utilized ports, wherein the recently utilized ports are arranged sequentially in the list based on a most recently utilized means for evaluating each of the recently utilized ports to determine if a source is coupled to one of the recently utilized ports; means for evaluating other ports not in the list if none of the recently utilized ports is coupled to the source; and means for updating the list if the recently utilized ports or the other ports is determined to be coupled to the source.

Additional aspects of the present invention will be set forth in part in the description which follows, and in part will be obvious from the description, or may be learned by practice of the invention. The aspects of the present invention will be realized and attained by means of the elements and combinations particularly pointed out in the appended claims.

Further, it is to be understood that both the foregoing general description and the following detailed description are exemplary and explanatory only and are not restrictive of the present invention, as claimed.

The accompanying drawings, which are incorporated in and constitute a part of this specification, illustrate several aspects of the present invention and together with the description, serve to explain the principles of the invention.

### BRIEF DESCRIPTION OF THE DRAWINGS

FIG. 1 is a diagram illustrating a system for displaying a video consistent with aspects of the present invention;

FIG. 2 is a rear view diagram illustrating a system for displaying a video consistent with aspects of the present invention;

FIG. 3a is a diagram illustrating a DLP video projector consistent with aspects of the present invention;

FIGS. 3b-f are various views illustrating an integrated video projector and video source consistent with aspects of the present invention;

FIGS. 4a and 4b are diagrams illustrating display screens consistent with aspects of the present invention;

FIGS. 5a-d are flow charts illustrating a method for evaluating ports consistent with aspects of the present invention; and

FIGS. 6, 7a-c, and 8a-c are diagrams illustrating a list of ports consistent with aspects of the present invention.

### DETAILED DESCRIPTION

Aspects of the present invention relate to systems and methods for determining if ports of a video display system are connected to a source. A list of most recently utilized ports is maintained in memory. The video display system checks each port in the recently utilized ports list to determine if any video sources are connected to the recently utilized ports. If no sources are connected to the recently utilized ports, the video display system sequentially checks the remaining ports not stored in the list. By limited the number of ports initially evaluated, a port which is connected to a video source may be determined quicker.

Reference will now be made in detail to various aspects of the present invention, examples of which are illustrated in the accompanying drawings. Wherever possible, the same reference numbers will be used throughout the drawings to refer to the same or like parts.

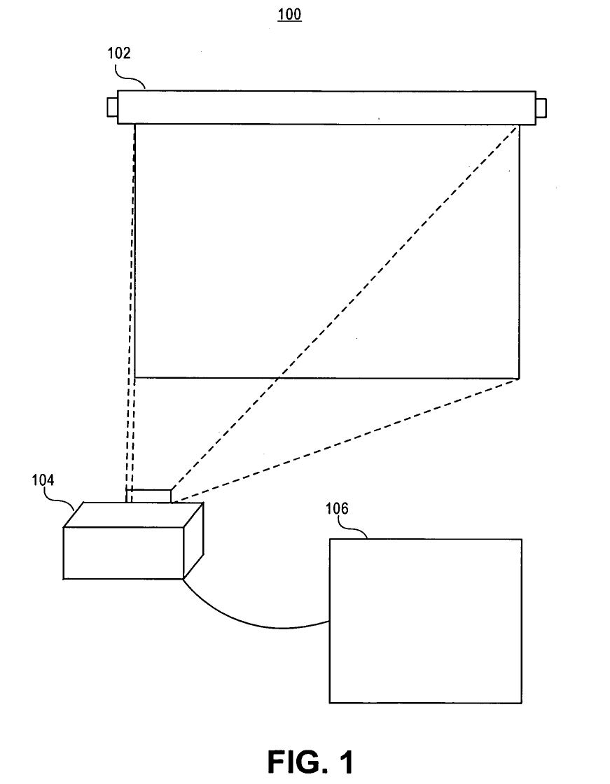

FIG. 1 illustrates a system 100 for displaying video consistent with aspects of the present invention. System 100 includes a display screen 102 for viewing video projected from a video projector 104. System 100 further includes a video source 106 which transmits a video signal to video projector 104. The video projected onto display screen 102 may be moving video or still images. Video projector 104 may be any type of video projector capable of receiving a video signal and converting the video signal to a viewable image to be displayed on display screen 102. For example, video projector 104 may be a digital light processing (“DLP”) video projector, a liquid crystal (“LCD”) video projector, or cathode-ray tube (“CRT”) projector.

As illustrated in FIG. 1, video source 106 supplies video projector 104 with a video signal to be displayed on video screen 102. Video source 106 may be any standard video equipment capable of generating a video signal readable by video projector 104. For example, video source 106 may be a Digital Versatile Disk (“DVD”) player, laser disk player, Compact Disk (“CD”) player, Video CD (“VCD”) player, VHS player/recorder, Digital Video Recorder (“DVR”), video camera, video still camera, cable receiver box, or satellite receiver box. Video source 106 may also be a standard laptop or desktop computer. One skilled in the art will realize that the preceding list of standard video equipment is exemplary and video source 106 may be any device capable of generating a video signal readable by video projector 104. Furthermore, video source 106 may be integrated with video projector 104. Additionally, video projector 104 may be coupled to multiple video sources 106.

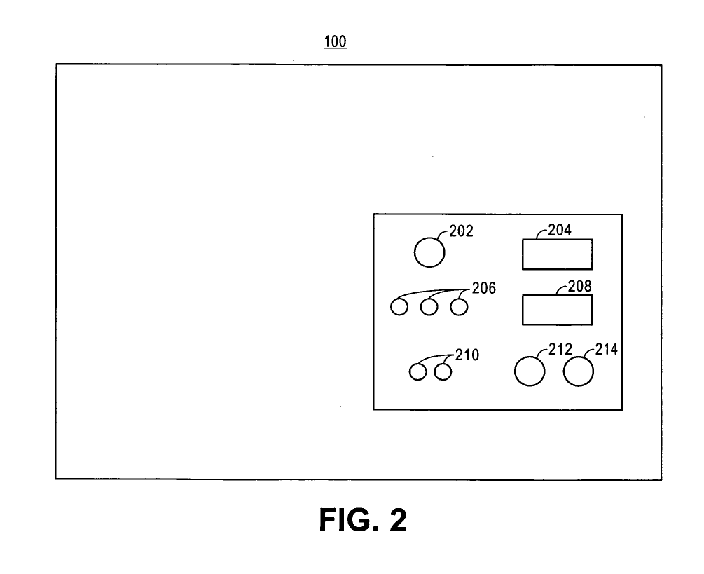

FIG. 2 is a back view of video projector 104 illustrating input/output ports 200 for sending and receiving signals consistent with aspects of the present invention. Video source 106 may be coupled to one of the input/output ports 200. As illustrated in FIG. 2, input/output ports 200 include a S-video input 202, DVI-I input 204, component video input 206, VGA input 208, audio input 210, coaxial video input 212, and coaxial audio input 214.

Input/output ports 200 may include additional input and output ports. For example, input/output ports 200 may include ports any number of a S-video input, S-video output, composite video input, composite video output, component video input, component video output, DVI-I video input, DVI-I video output, coaxial video input, coaxial video output, audio input, audio output, infrared input, infrared output, RS-232 input, RS-232 output, VGA input, or VGA output. One skilled in the art will realize that the preceding list of input and output ports is exemplary and that input/output ports 200 may include any port capable of sending or receiving an electrical signal. Input/output ports 200 are coupled to the internal components of video projector 104.

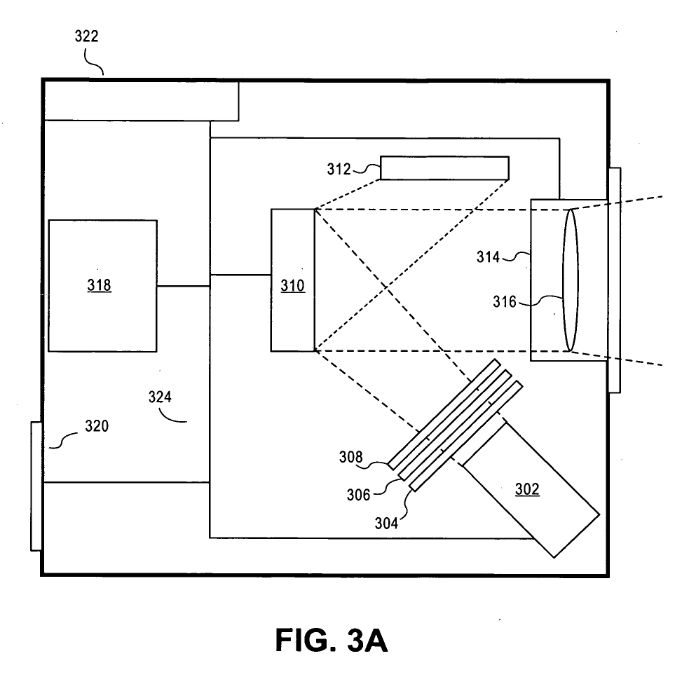

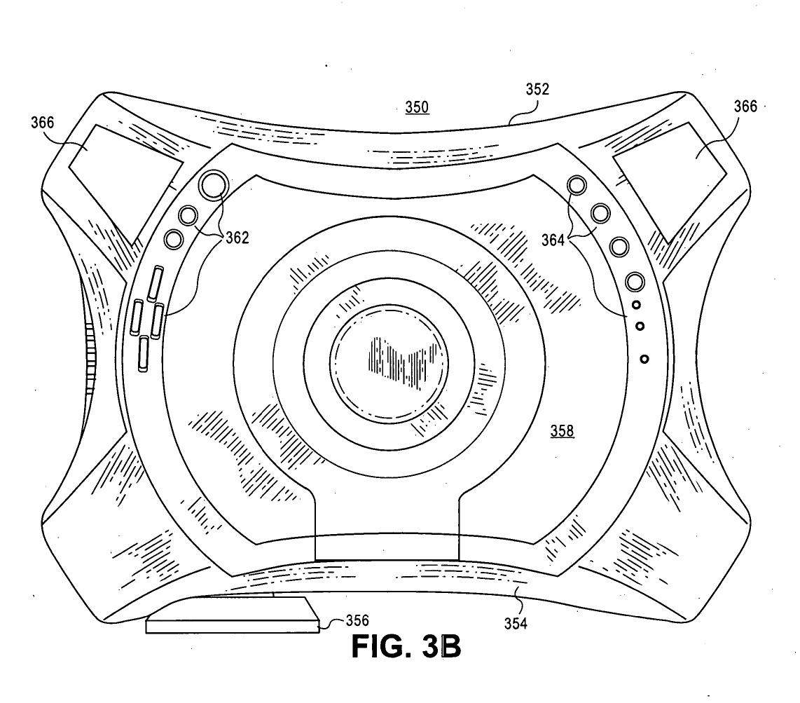

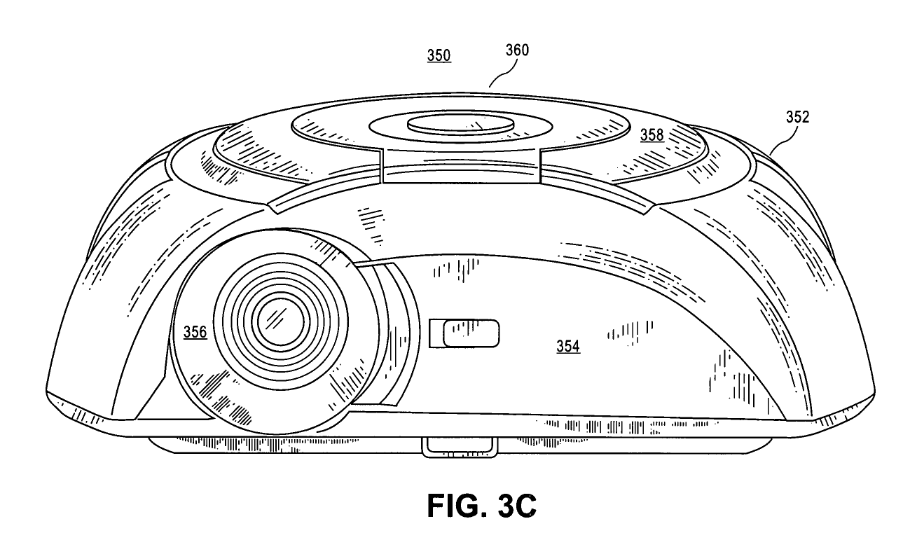

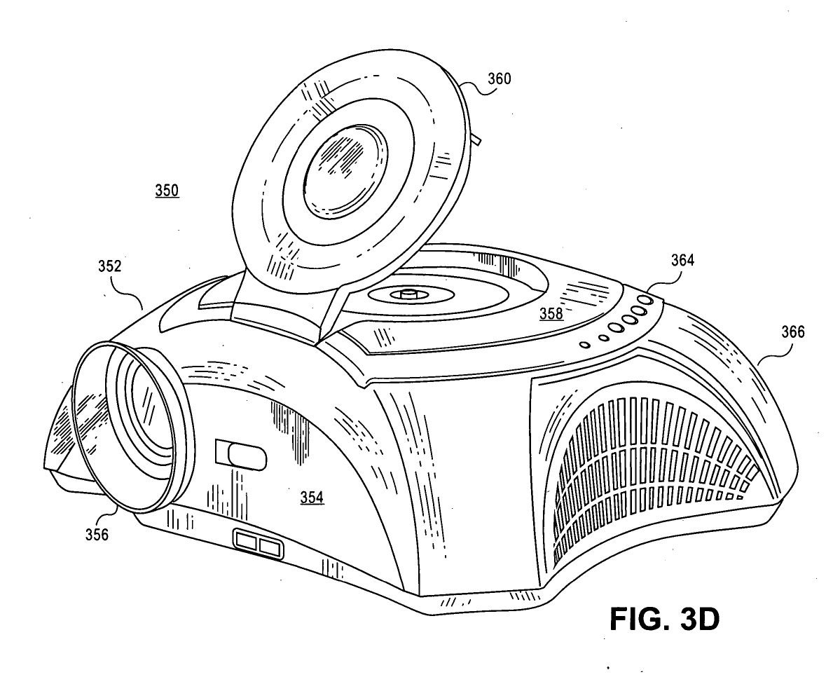

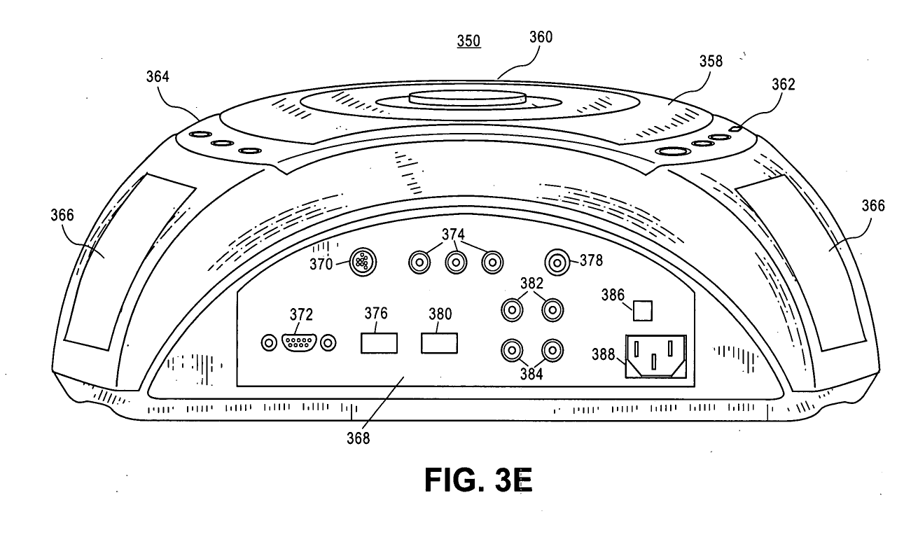

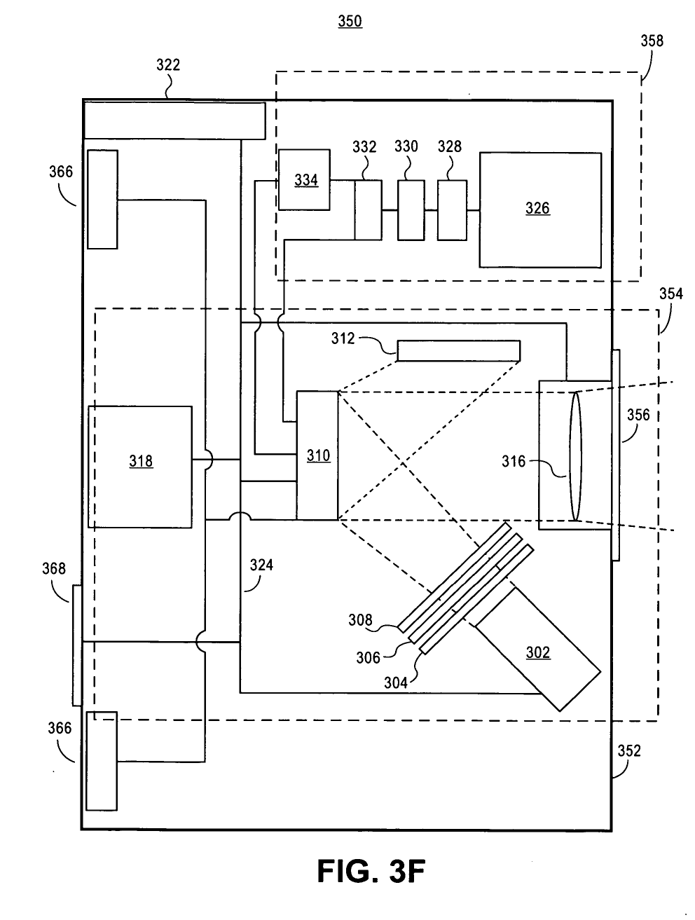

FIG. 3a illustrates an exemplary DLP video projector 300 which may be used as video projector 104. DLP video projector 300 is an example of one type of projector which may be used with system 100. One skilled in the art will understand that any type of video projector may be used with system 100 such as a CRT projector or an LCD projector.

DLP video projector 300 may include a controller 318 and a bus 324. Controller 318 may include components to control and monitor DLP video projector 300. For example, controller 318 may include a processor, non-volatile memory, and mass storage. All the components of DLP video projector 300 may be coupled to bus 324 to allow all the components to communicate with controller 318 and one another. DLP video projector 300 includes a fan 322 to cool DLP video projector 300. Fan 322 may be coupled to bus 324. DLP video projector 300 also includes a power supply (not shown) coupled to all the components.

DLP video projector 300 contains a light source 302 for generating light to produce a video image. Light source 302 may be, for example, an ultra-high performance (“UHP”) lamp capable of producing from 50-500 watts of power. Light source 300 may be coupled to bus 324 to communicate with other components. For example, controller 318 or DLP circuit board 310 may control the brightness of light source 302.

Light generated by light source 302 passes though optics 304, 308 and color filter 306. Optics 304 and 308 may be, for example, a condenser and a shaper, respectively, for manipulating the light generated by light source 302. Color filter 306 may be, for example, a color wheel capable of spinning at various speeds to produce various colors.

Video projector 300 also contains a DLP circuit board 310. DLP circuit board 310 may include a digital micro-mirror device, a processor, and memory. For example, DLP circuit board 310 may be a DARKCHIP2 or DARKCHIP3 DLP chip manufactured by TEXAS INSTRUMENTS. DLP circuit board 310 is coupled to bus 324 to receive the video signal received from input/output ports 320 and to communicate with controller 318. DLP circuit board 310 reflects light from light source 302 using the digital micro-mirrors and generates video based on the video signal to be displayed on video screen 202. DLP circuit board 310 reflects light not used for the video onto light absorber 312. Light reflected by DLP circuit board 310 used for the video passes through lens housing 314 and lens 316. Lens 316 focuses the video to be displayed on display screen 102. Lens housing 314 may include a manual lens moving mechanism or a motor to automatically move lens 316. The manual lens moving mechanism or motor allows the position of lens 316 and, as a result, shift the position of the video displayed on display screen 102. The shifting may be achieved by moving lens 316 in any combination of the x, y, or z directions.

DLP video projector 300 also includes input/output ports 320. Input/output ports 320 may be a single port or multiple ports. Input/output ports 320 enables DLP video projector to receive video signals, receive signals from a remote control device, and output signals to other sources. For example, input/output ports 320 may include ports as illustrated in FIG. 2 or any number of a S-video input, S-video output, composite video input, composite video output, component video input, component video output, DVI-I video input, DVI-I video output, coaxial video input, coaxial video output, audio input, audio output, infrared input, infrared output, RS-232 input, RS-232 output, VGA input, or VGA output. One skilled in the art will realize that the preceding list of input and output ports is exemplary and that input/output ports 320 may include any port capable of sending or receiving an electrical signal. Input/output ports 320 are coupled to bus 324. Signals input into DLP video projector 300 may be transferred to the various components of DLP video projector 300 via bus 324. Likewise, signals output of DLP video projector 300 may be transferred to input/output ports 320 via bus 324.

As stated above, video source 106 may be integrated with video projector 104. FIGS. 3b-f are various views of a video projection system 350 which includes a video source and video projector integrated into a single housing 352 consistent with aspects of the present invention. Video projection system 350 may be utilized as system 104 in video system 100. FIG. 3b is a top view of video projection system 350 consistent with aspects of the present invention. As shown in FIG. 3b, video projection system 350 includes video projector 354 and a video source 358 in a single housing. For example, video projector 354 may be a DLP projector and video source 358 may be a DVD player. Video projection system 350 includes a lens housing 356 located in a front portion of video projector 354. Lens housing 356 may include various lens used in projecting video onto a display screen. Further, video source 358 includes a tray 360 for housing media read by video source 358. For example, if video source 358 is a DVD player, tray 360 may house DVD discs.

Further, as illustrated in FIG. 3b, video projection system 350 includes projector controls 362 for operating video projector 354. For example, projector controls 362 may be a power switch, zoom controls, input/output select controls, and picture mode controls. Video projection system 350 also includes video source controls 364. For example, video source controls 364 may be tray open/close controls, play/stop controls, and video search controls for operating video source 358. Video projection system 350 may also be controlled by a remote device (not shown). For example, a remote device may include redundant projector controls 362 and video source controls 364. Video projection system 350 also includes speakers 366 for presenting sounds corresponding to video generated by video projection system 350.

FIG. 3c is a front view of video projection system 350. As shown in FIG. 3c, lens housing 356 is located in the front portion of housing 352 of video projection system 350. Further, video source 358 and tray 360 may be housed in the top portion of housing 352 of projection system 350. FIG. 3d is another front view of video projection system 350. FIG. 3d illustrates video projection system 350 when tray 360 is open for inserting media to be played by video source 358.

FIG. 3e is a rear view of video projection system 350. As illustrated in FIG. 3e, input/output ports 368 are located in a rear portion of housing 352 of video projection system 350. For example, input/output ports 368 may include an S-video input 370, DVI-I input 372, component video input 374, VGA input 376, composite video input 378, RS-232 port 380, audio input 382, audio output 384, and optical audio output 386, and power input 388. Input/output ports 368 may include additional input and output ports (not shown). For example, input/output ports 368 may include ports any number of a S-video input, S-video output, composite video input, composite video output, component video input, component video output, DVI-I video input, DVI-I video output, coaxial video input, coaxial video output, audio input, audio output, infrared input, infrared output, RS-232 input, RS-232 output, VGA input, or VGA output. One skilled in the art will realize that the preceding list of input and output ports is exemplary and that input/output ports 368 may include any port capable of sending or receiving an electrical signal.

Further, as illustrated in FIG. 3e, speakers 366 are located in the sides of the rear portion of housing 352 of video projection system 350. Of course, speakers 366 may also be located in other portions of housing 352. In addition, video projection system 350 may be coupled to other speakers (not shown) that are external to housing 352.

FIG. 3f is a block diagram illustrating internal components of video projection system 350 consistent with aspects of the present invention. As illustrated in FIG. 3f, video projection system 350 includes a DLP video projector 354 and a DVD player 358 integrated into a single housing 352. DLP video projector 354 is an example of one type of projector which may be used with video projection system 350. One skilled in the art would understand that any type of video projector may be used with video projection system 350 such as a CRT projector or an LCD projector. Further, DVD player 358 is an example of one type of video source which may be used with video projection system 350. One skilled in the art will understand that any type of video source may be used with video projection system 350.

DLP video projector 354 may include a controller 318 and a bus 324. Controller 318 may include components to control and monitor DLP video projector 354. For example, controller 318 may include a processor, non-volatile memory, and mass storage. All the components of DLP video projector 354 may be coupled to bus 324 to allow all the components to communicate with controller 318 and one another. DLP video projector 354 includes a fan 322 to cool DLP video projector 354. Fan 322 may be coupled to bus 324. DLP video projector 354 also includes a power supply (not shown) coupled to all the components.

DLP video projector 354 contains a light source 302 for generating light to produce a video image. Light source 302 may be, for example, an UHP lamp capable of producing from 50-500 watts of power. Light source 300 may be coupled to bus 324 to communicate with other component. For example, controller 318 or DLP circuit board 310 may control the brightness of light source 302.

Light generated by light source 302 passes though optics 304, 308 and color filter 306. Optics 304 and 308 may be, for example, a condenser and a shaper, respectively, for manipulating the light generated by light source 302. Color filter 306 may be, for example, a color wheel capable of spinning at various speeds to produce various colors.

DLP projector 354 also contains a DLP circuit board 310. DLP circuit board 310 may include a digital micro-mirror device, a processor, and memory. For example, DLP circuit board 310 may be a DARKCHIP2 or DARKCHIP3 DLP chip manufactured by TEXAS INSTRUMENTS. DLP circuit board 310 is coupled to bus 324 to receive the video signal received from input/output ports 320 and to communicate with controller 318. DLP circuit board 310 reflects light from light source 302 using the digital micro-mirrors and generates video based on the video signal to be displayed on display screen 102. DLP circuit board 310 reflects light not used for the video onto light absorber 312. Light reflected by DLP circuit board 310 used for the video passes through lens housing 356 and lens 316. Lens 316 focuses the video to be displayed on display screen 102. Lens housing 356 may include a manual lens moving mechanism or a motor to automatically move lens 316. The manual lens moving mechanism or motor allows the position of lens 316 and, as a result, shift the position of the video displayed on display screen 102. The shifting may be achieved by moving lens 316 in any combination of the x, y, or z directions.

DLP video projector 354 also includes input/output ports 368. Input/output ports 368 may be a single port or multiple ports. Input/output ports 368 enables DLP video projector 354 to receive video signals, receive signals from a remote control device, and output signals to other sources. For example, input/output ports 368 may include ports as illustrated in FIG. 3e or any number of a S-video input, S-video output, composite video input, composite video output, component video input, component video output, DVI-I video input, DVI-I video output, coaxial video input, coaxial video output, audio input, audio output, infrared input, infrared output, RS-232 input, RS-232 output, VGA input, or VGA output. One skilled in the art will realize that the preceding list of input and output ports is exemplary and that input/output ports 368 may include any port capable of sending or receiving an electrical signal. Input/output ports 368 are coupled to bus 324 and to audio bus 336. Signals input into DLP video projector 354 may be transferred to the various components of DLP video projector 354 via bus 324. Likewise, signals output of DLP video projector 354 may be transferred to input/output ports 368 via bus 324.

DLP video projector 354 also includes DVD player 358. DVD player 358 is composed DVD reader 326. DVD reader 326 may include a spindle motor for turning a DVD disc, a pickup head, and a head amplifier equipped with an equalizer. DVD reader 326 is coupled to a decoder/error correction circuit 328, a content scrambling system 330 for copy protecting DVD contents, a program stream demultiplexer (“PS demultiplexer”) 332.

DVD player reads a DVD disc with DVD reader 326 by emitting laser light from the pickup head in order to irradiate the DVD disc with a predetermined wavelength. The reflected light is converted to an electric signal which is then output to the head amplifier. The head amplifier serves to perform signal amplification, waveform shaping and digitization while decoder/error correction circuit 328 serves to perform 8-16 decoding and error correction. Next, content scrambling system 330 performs mutual authentication of the DVD disc and DVD player 358 in order to confirm the authorization.

When the authorization is successfully finished, PS demultiplexer 332 separates the program stream (“PS”) as read from the DVD disc into sound and video data in the form of packetized elementary streams (“PES”). Audio stream decoder 334 decodes the PES sound stream with sound compression encoding technology in order to output audio signals. For example, audio stream decoder may utilize sound compression formats such as AAC, AC3, and MPEG. DLP circuit board 310 decodes and processes the video PES which would include video, sub-picture, and navigation data. For example, DLP circuit board 310 may utilize video compression formats such as MPEG 2. The decoded sound stream is transferred to DLP circuit board 310 and DLP circuit board 310 synchronizes sounds, which is transferred to speakers 366 via sound bus 336 and video, which is generated by DLP video projector 354.

One skilled in the art will realize that controller 318 may be utilized in combination with DLP circuit board 310 for producing video and sound from DVD player 358. Further, DLP circuit board 310 or controller 318 may perform audio decoding functions similar to the functions as performed by audio stream decoder 334.

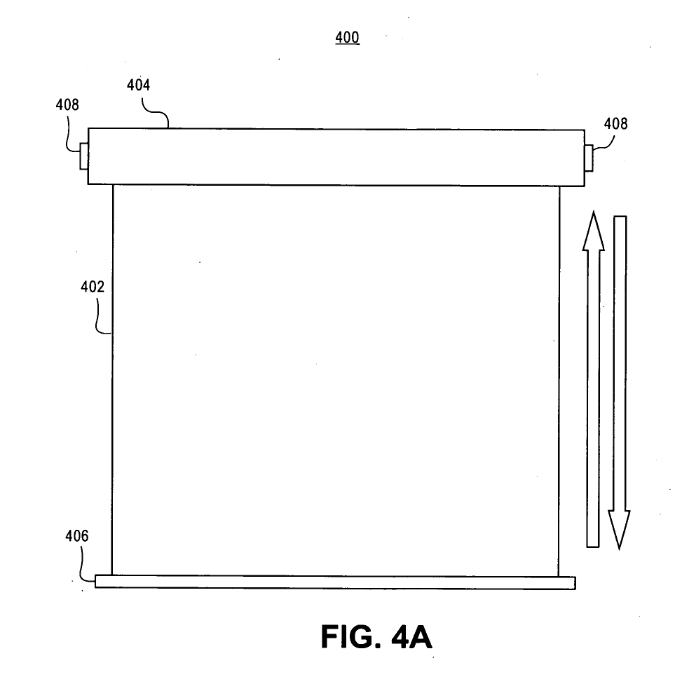

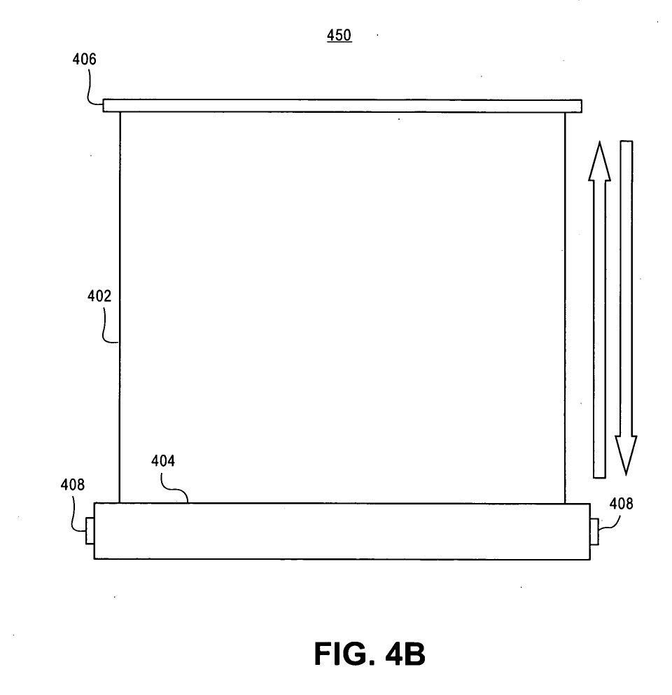

FIG. 4a illustrates a detailed view of display screen 400 which may be used as display screen 102 consistent with aspects of the present invention. Display screen 400 is merely an example of one type of display screen which may be used with system 100. One skilled in the art would understand that any type of display screen capable of displaying an image may be used with system 100. Display screen 400 includes a viewing screen 402 that retracts into a housing 404. Viewing screen 400 may be constructed of materials that efficiently reflect the video projected from video projector 104. For example, viewing screen 404 may be constructed of a white or gray vinyl fabric, glass beaded fabric, VIDEO SPECTRA fabric, High Contrast-fabric, or High Power fabric. One skilled in the art would realize that the above materials are exemplary and that viewing screen 402 may be constructed of any material or combination of materials that reflects light. Optionally, a weight 406 is attached to the bottom of viewing screen 402 to stabilize viewing screen 402.

Display screen 400 also includes mounting brackets 408 which enable display screen 400 to be attached to a wall or ceiling. FIG. 4 illustrates mounting brackets 408 as located on the sides of housing 404. Mounting brackets 408 may be located on any surface of housing 404 to facilitate the mounting of display screen 400.

Viewing screen 402 may be manually or electrically retracted into housing 404. If viewing screen 402 is manually retracted, housing 404 contains an inertial locking mechanize and roller (not shown) attached to viewing screen 402. The inertial locking mechanize enables a user to apply force to viewing screen 402 in order to retract or extend viewing screen 402. As the viewing screen 402 retracts, viewing screen 402 is wound around the roller.

If viewing screen 402 is electrically retracted, housing 404 contains an electrical motor and roller (not shown) attached to viewing screen 404. To electrically operate viewing screen 402, current is supplied to the electrical motor to activate the motor and wind viewing screen 402 around the roller in order to retract or extend viewing screen 402 into housing 402. The current supplied to the electrical motor may be controlled by a switch (not shown) located on housing 404. Additionally, a wireless receiver (not shown) may be attached to the electrical motor to enable the electrical motor to be controlled remotely. Additionally, a memory may be attached to the motor in order to store different viewing screen positions to be recalled when needed.

FIG. 4b is a diagram illustrating a display screen 450 which may be used as display screen 102 consistent with aspects of the present invention. Display screen 450 includes a viewing screen 402, a housing 404, an optional weight 406, and optional mounting brackets 402 as display screen 400. Display screen 450 functions in the same manner as display screen 400 except that viewing screen 402 extends upward out of housing 404. Display screen 450 is merely an example of one type of display screen which may be used with system 100.

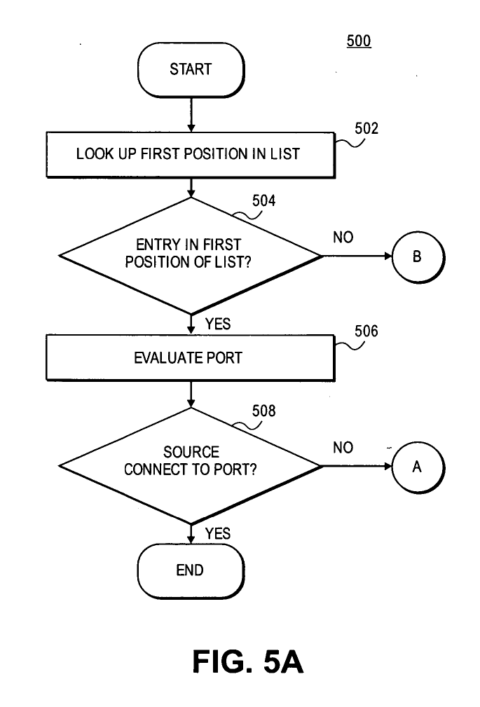

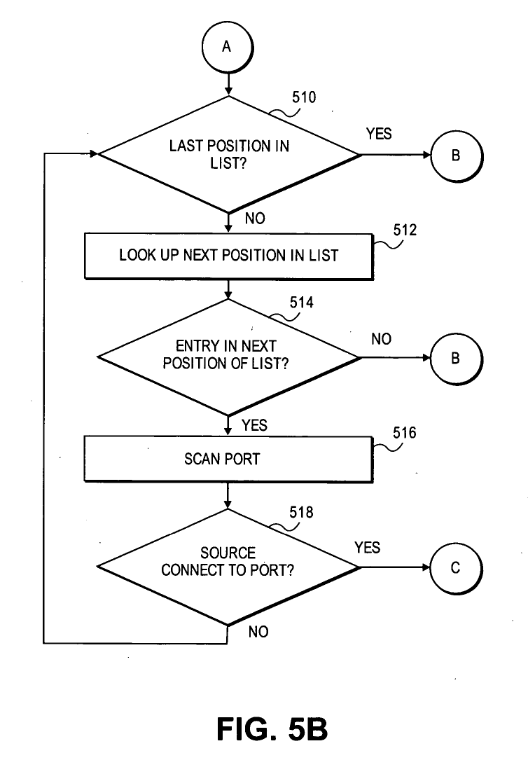

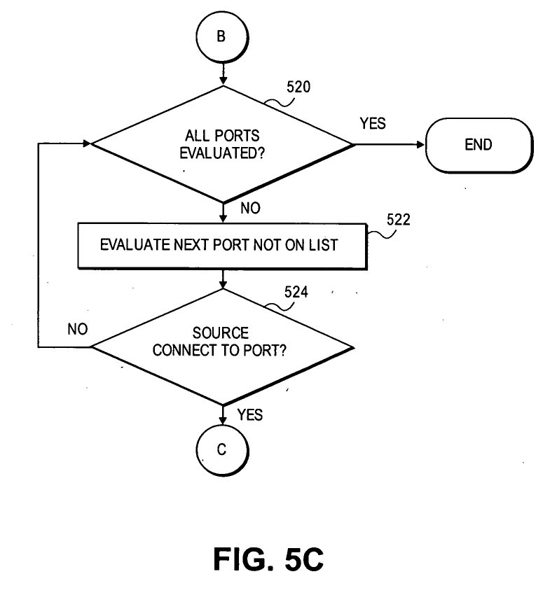

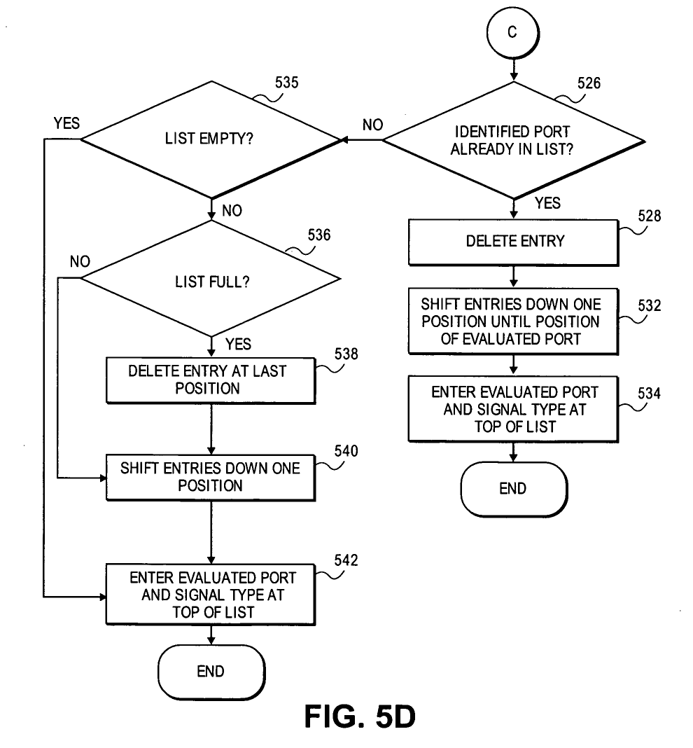

FIGS. 5a-5d illustrate a method 500 for detecting a source connected to input/output ports 200. Method 500 increases the speed for determining if a source 106 is connected to input/output ports 200 of video projector 104 by utilizing a most recent ports list. Method 500 may be performed in a variety of situations. For example, video projector 104 may perform method 500 when video projector 104 is powered up. Further, video projector 104 may perform method 500 periodically once powered up to determine if any new sources 106 have been attached. Further, video projector may perform method 500 in response to a user command to search for a source 106. One skilled in the art would realize that the above situations for performing method 500 are exemplary and that method 500 may be performed in any situation that input/output ports 200 are evaluated.

Method 500 may be performed by any control and processing hardware, software, or combination thereof contained in video projector. For example, if DLP projector 300 or 350 is utilized, method 500 may be performed by controller 318, by DLP circuit board 310, by software stored in controller 318, or by software stored in DLP circuit board 310. One skilled in the art will realize that method 500 being performed by the components of DLP projector 300 or 350 is exemplary and that method 500 may be performed by any hardware, software, or combination thereof capable of performing processing and evaluation of input/output ports 200.

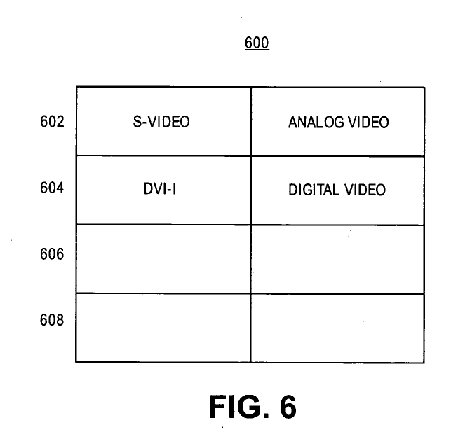

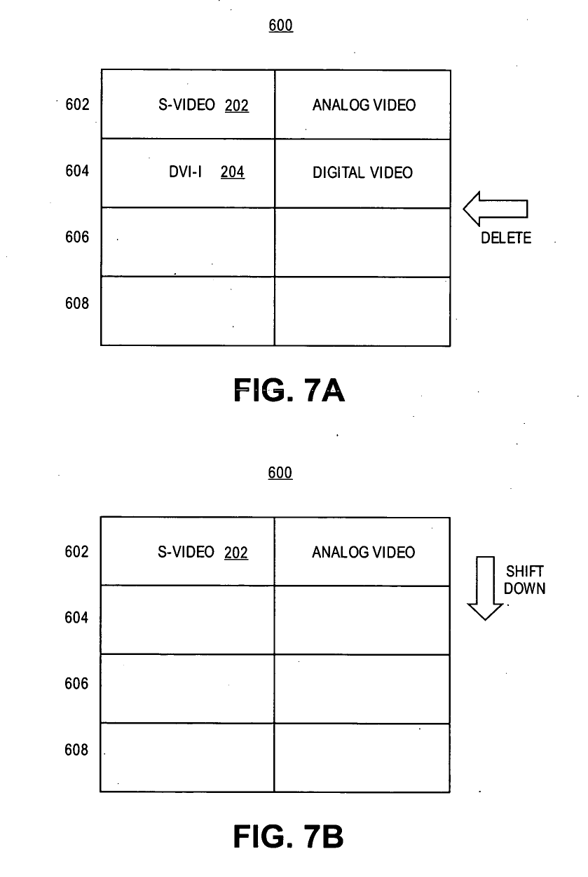

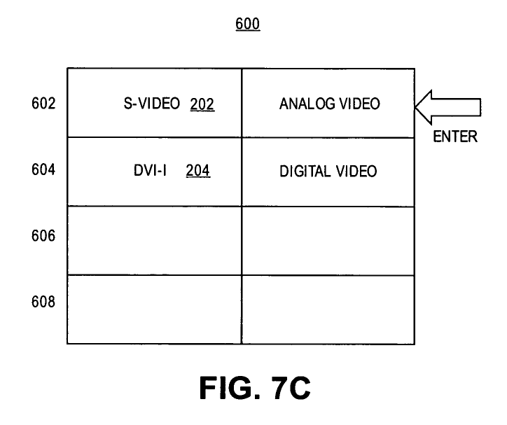

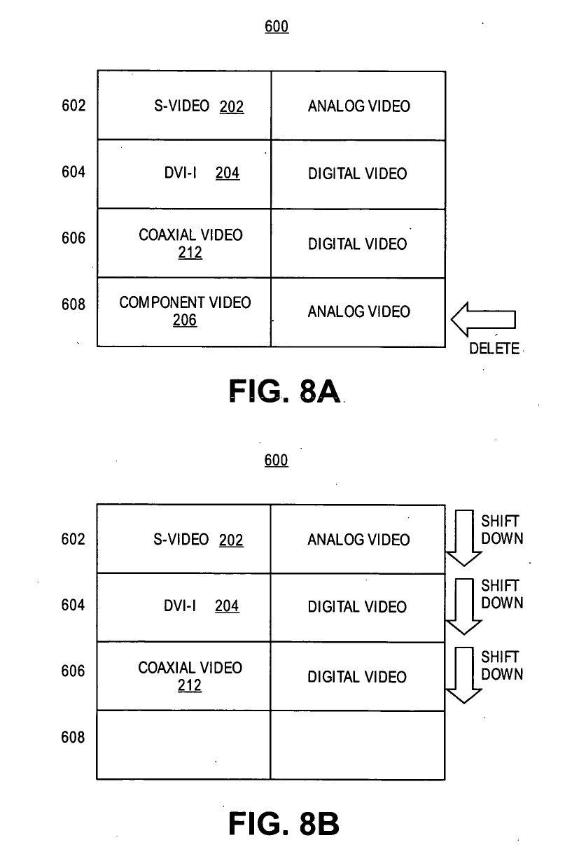

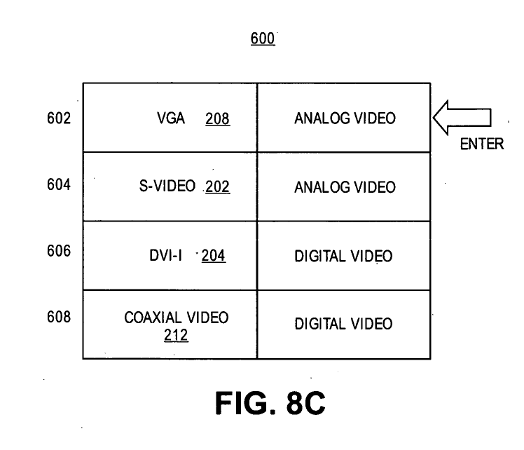

FIGS. 6, 7a-c, and 8a-c illustrate an exemplary list 600 during various stages of method 500 consistent with aspects of the present invention. The most recently evaluated ports list, including list 600, may be stored in memory in video projector 104. For example, if DLP video projector 300 or 350 is utilized, the most recently evaluated ports list may be stored non-volatile memory in controller 318 or in memory of DLP circuit board 310. As illustrated in FIGS. 6, 7a-c, and 8a-c, list 600 includes four entry positions 602, 604, 606, and 608 for entering the most evaluated input/output ports 200 and the type of signal received by input/output ports 200. Positions 602, 604, 606, 608 are sequentially ordered beginning with position 602 which is the first position and contains the most recently evaluated input/output port 200. One skilled in the art will realize that list 600 is exemplary and that list 600 may include any number of entry positions for storing data regarding input/output ports 200. Further, one skilled in the art will realize that the most recently used list may be stored in any memory device couple to video projector 104 including but not limited to memory devices contained in source 106.

As illustrated in FIG. 5a, video projector 104 begins by looking up first position 602 of list 600 (stage 502) and determining if any input/output port 200 is located in first position 602 (stage 504). If first position 602 of list 600 contains an input/output port 200, video projector 104 evaluates the listed input/output port 200 (stage 506) and determines if a source 106 is connected to the listed input/output port 200 (stage 508). As illustrated in FIG. 6a, S-video port 202 may be listed in first position 602 of list 600. If so, video projector 104 evaluates S-video 202 port to determine if a source 106 is connected to S-video port 202.

If a source 106 is connected to input/output 200 listed in first position 602 of list 600, video projector 104 identifies this port as connected to a source 106 and method 500 ends. If a source 106 is not connected to input/output 200 listed in first position 602 of list 600, video projector 104 proceeds with checking the remaining entries in positions 604, 606, and 608, if any, in list 600. As shown in FIG. 5b, video projector 104 determines if the last checked position is last position 608 in list 600 (stage 510). If the last checked position is last position 608 in list 600, video projector 104 proceeds with checking each input/output port 200 not entered in list 600 sequentially (FIG. 5c). If the last checked position is not last position 608 in list 600, video projector 104 proceeds with evaluating input/output port 200 entered in the next position of list 600.

Video projector 104 looks up the next position of list 600 (stage 512) and determines if any entry is located in next position 604 (stage 514). If an entry is not in the next position, video projector 104 proceeds with checking each input/output port 200 not entered in list 600 sequentially (FIG. 5c). If next position 604 of list 600 contains an entry, video projector 104 evaluates the listed input/output port 200 (stage 516) and determines if a source 106 is connected to the listed input/output port 200 (stage 518). As illustrated in FIG. 6a, DVI-I port 204 is listed in next position 604 of list 600. Video projector 104 evaluates DVI-I port 204 to determine if a source 106 is connected to DVI-I port 204.

If a source is connected to input/output 200 listed in 604 next position of list 600, video projector 104 identifies this port as connected to a source 106 and video projector 104 proceeds with updating list 600 as illustrated in FIG. 5d. If a source 106 is not connected to input/output 200 listed in next position 604 of list 600, video projector 104 proceeds with checking the remaining entries in position 606 and 608, if any, in list 600 by repeating stages 510-518.

FIG. 5c illustrates stages performed in method 500 if all the input/output ports 200 entered in list 600 are evaluated and determined not to have a source 106 connected or if no input/output ports 200 are entered in list 600. First, video projector 104 determines if all input/output ports 200 have been evaluated (stage 520). If all input/output ports 200 have been evaluated, method 500 ends. If any input/output ports 200 have not been evaluated, video projector 104 evaluates the next input/output port 200 not entered in list 600 (stage 522) and determines if a source 106 is connected to the next input/output port 200 (stage 524). If a source 106 is connected to the next input/output port 200, video projector 104 identifies this input/output port 200 as being connected to a source 106 and video projector 104 proceeds with updating list 600 as illustrated in FIG. 5d. If a source 106 is not connected to the next input/output 200, video projector 104 proceeds with checking the remaining input/output ports 200 by repeating stages 520-524.

FIG. 5d illustrates stages in method 500 for updating list 600 once a source is found to be connected to input/output port 200. First, video projector 104 determines whether evaluated input/output port 200 is already entered in list 600 (stage 526). If evaluated input/output port 200 is already entered in list 600, video projector 104 deletes evaluated input/output 200 from list 600 (stage 528). Video projector 104 shifts all the entries beginning with the first entry up to the deleted entry down one position (stage 532). Then, video projector 104 enters the evaluated input/output port 200 at first position 602 of list 600 (stage 534). FIGS. 7a-7c illustrate updating list 600 performed at stages 528-534.

If evaluated input/output port 200 is not already entered in list 600, video projector 104 determines if list 600 is empty (stage 535). If list 600 is empty, video projector 104 enters the evaluated input/output port 200 at first position 602 of list 600 (stage 542). If list 600 is not empty, video projector 104 determines if list 600 is full (stage 536). If list 600 is full, video projector 104 deletes the entry in last position of in list 600 to make room for evaluated input/output port 200 (stage 538). Then, video projector 104 shifts all the entries down one position in list 600 (stage 540). Then, video projector 104 enters the evaluated input/output port 200 at first position 602 of list 600 (stage 542). FIGS. 8a-8c illustrate updating list 600 if list 600 is full and the evaluated input/port 200 is VGA port 208 performed at stages 536-542.

Other aspects of the present invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for detecting a video signal, comprising:
maintaining a list of recently utilized ports, wherein the recently utilized ports are arranged sequentially in the list based on a most recently utilized port;
evaluating each of the recently utilized ports to determine if a source is coupled to one of the recently utilized ports;
evaluating other ports not contained in the list if none of the recently utilized ports is coupled to the source; and
updating the list if the recently utilized ports or the other ports is determined to be coupled to the source.

2. The method of claim 1, wherein the list includes a type of the recently utilized ports and a type of signal received by the recently utilized port.

3. The method of claim 1, wherein updating the list comprises:
determining if an identified port coupled to the source is stored in the list;
deleting the identified port from the list if the identified port is stored in the list;
shifting the recently utilized ports located above the identified port sequential position to a lower sequential position until; and
entering the identified port at a first sequential position of the list.

4. The method of claim 1, wherein updating the list comprises:
determining if an identified port coupled to the source is stored in the list;
determining whether the list is empty if the identified port is not in the list; and
entering the identified port at a first sequential position of the list if the list is empty.

5. The method of claim 4, further comprising:
determining whether the list is full if the identified port is not empty;
deleting the recently utilized port stored at a last sequential position of the list if the list is full;
shifting all the recently utilized ports stored in the list down one sequential position; and
entering the identified port at the first sequential position of the list.

6. The method of claim 1, wherein evaluating each of the recently utilized ports comprises:
determining whether a first sequential position of the list contains the most recently utilized port; and
evaluating the most recently utilized port.

7. The method of claim 6, further comprising:
determining whether the list contains other recently utilized ports; and
evaluating the other recently utilized ports if the source is not coupled to the most recently utilized port.

8. The method of claim 7, further comprising:
sequential evaluating the other recently utilized ports until the source is determined to be couple to one of the other recently utilized ports.

9. A video device, comprising:
a video display device display video;
ports coupled to the video display device for receiving signals including video signals;
memory for maintaining a list of recently utilized ports, wherein the recently utilized ports are arranged sequentially in the list based on a most recently utilized; and
logic for evaluating each of the recently utilized ports to determine if a source is coupled to one of the recently utilized ports, evaluating other ports not in the list if none of the recently utilized ports is coupled to the source, and updating the list if the recently utilized ports or the other ports is determined to be coupled to the source.

10. The device of claim 9, wherein the video display device comprises:
a video projection device coupled to the ports for generating the video based on the video signals.

11. The device of claim 10, wherein the video projection device comprises:
a lens capable of shifting video generated by the video projection device.

12. The device of claim 11, wherein the video projection device comprises:
a non-volatile memory for storing a position of the lens.

13. The device of claim 11, wherein the video projection device comprises:
a memory for storing a dimension of a display screen.

14. The device of claim 10, wherein the source and the video projection device are located in the same housing.

15. A video device, comprising:
means for displaying video;
means for receiving signals including video signals;
means for maintaining a list of recently utilized ports, wherein the recently utilized ports are arranged sequentially in the list based on a most recently utilized
means for evaluating each of the recently utilized ports to determine if a source is coupled to one of the recently utilized ports;
means for evaluating other ports not in the list if none of the recently utilized ports is coupled to the source; and
means for updating the list if the recently utilized ports or the other ports is determined to be coupled to the source.

16. The device of claim 15, wherein the video displaying means comprises means for shifting video displayed by the video display means.

17. The device of claim 16, wherein the video displaying means comprises means for storing a position of the shifted video.

18. The device of claim 17, wherein the source and the video displaying means are located in the same housing.

19. The device of claim 16, wherein the video displaying means comprises means for storing a dimension of a display screen.

20. The device of claim 16, further comprising:
means for determining a type of the recently utilized ports; and
means for determining a type of signal received by the recently utilized port.
